(19) United States
(12) Patent Application Publication
(10) Pub. No.: US 2023/0242084 A1
(43) Pub. Date: Aug. 3, 2023

(54) BRAKE CONTROLLER WITH PITCH/ROLL COMPENSATION

(71) Applicant: REDARC TECHNOLOGIES PTY LTD [AU/AU], Morphett Vale,South Australia (AU)

(72) Inventor: Timothy Fosdike, Torrens Park (AU)

(21) Appl. No.: 18/042,947

(22) PCT Filed: Aug. 24, 2021
(86) PCT No.: PCT/AU2021/050942

§ 371 Date: Feb. 24, 2023

(51) Int. Cl. B60T 7/20; B60T 8/24; B60T 8/32

(52) U.S. Cl. CPC B60T 7/20; B60T 8/248; B60T 8/323; B60T 2230/06

(57) ABSTRACT

The present invention relates to a brake controller for an accelerometer based towed vehicle braking system and a method of operating the brake controller.

### TECHNICAL FIELD

The present invention relates to a brake controller for an accelerometer based towed vehicle braking system and a method of operating the brake controller.

### BACKGROUND OF INVENTION

Towed vehicles such as trailers of various classes have different braking systems. Commonly, trailers with weights between 750 kg and 4.5 tons have electromagnetic braking systems or hydraulic braking systems controlled by electromagnetic actuators. For both of these systems the braking force in the trailer is controlled by an electrical signal from the towing vehicle.

Historically, the level of trailer braking was controlled by a simple manual adjustment of output level. More recently, trailer braking systems exist that attempt to provide a simpler user experience by providing trailer braking proportional to towing vehicle braking. One common way to implement this is to use an accelerometer or pendulum to measure vehicle braking force and to apply proportional force with the trailer brakes. Known products using an accelerometer to measure vehicle braking force have been required to be installed in a particular orientation to allow braking force to be measured along a single axis.

It would be desirable to provide a more versatile brake controller that may be mounted outside of the towing vehicle, such as on the towed vehicle or between the towing vehicle and the towed vehicle. In particular, it may be desirable to have a brake controller that can be mounted on a wiring loom rather than fixed to the chassis. However, it will be understood that mounting the brake controller in such ways causes challenges to arise since the accelerometer may measure not only the braking deceleration, but also artefacts. Artefacts that may be measured include i) noise from road; ii) gravity; iii) sway on vehicle springs; iv) sway due to wiring loom movement; v) variations in road slope; and vi) centripetal acceleration. Designs for brake controllers exist that compensate for (ii) by eliminating components not in the horizontal plane. However, such systems remain sensitive to rotation rate of the brake controller they do not compensate for (ii) or for horizontal components of the various artefacts described. Accordingly, existing systems that measure only forward acceleration require mounting at a specific, or at least a fixed angle to the vehicle axes.

A reference herein to a patent document or other matter which is given as prior art is not to be taken as an admission that that document or matter was known or that the information it contains was part of the common general knowledge in Australia or elsewhere as at the priority date of any of the disclosure or claims herein. Such discussion of prior art in this specification is included to explain the context of the present invention in terms of the inventor's knowledge and experience.

### SUMMARY OF THE INVENTION

According to an aspect of the present invention, there is provided a brake controller for a towed vehicle braking system, the brake controller adapted to generate a braking control signal to the towed vehicle braking system, the brake controller comprising at least one inertial sensor adapted to sense inertial measurements in more than three sensor axes and generate sensor data associated with each of the sensor axes; a processor for processing the sensor data to estimate a braking deceleration; wherein the brake controller is adapted to generate the braking control signal to control activation of at least one brake associated with the towed vehicle braking system based on the braking deceleration in a manner that is relatively insensitive to sensed forces other than the braking deceleration thereby adapting the brake controller to be mounted in various orientations that need not be fixed relative to the towed vehicle or a towing vehicle.

The inertial measurements may include one or more of acceleration, rotation rate or angle.

In an embodiment, the brake controller is adapted to be mounted outside of the towing vehicle.

In another embodiment, the brake controller is adapted to be mounted in the towed vehicle or between the towing vehicle and the towed vehicle. The brake controller may be adapted to be mounted on a wiring loom between the towing vehicle and the towed vehicle.

In various embodiments, the orientation of the brake controller is changing in at least one of a pitch, roll or yaw direction.

In certain embodiments, adapting the brake controller to be insensitive to forces other than the braking deceleration involves compensating for one or more extraneous acceleration components when generating the braking signal.

The extraneous acceleration components may be attributed to one or more of the following: acceleration due to gravity; acceleration due to sway on springs; acceleration due to wiring loom sway; acceleration due to change in road slope; acceleration rate due to road noise; or centripetal acceleration of tow vehicle or trailer.

In some embodiments, adapting the brake controller to be insensitive to forces other than braking deceleration involves compensating for one or more rotation rate components when generating the braking control signal.

The rotation rate components may be attributed to one or more of the following: rotation rate due to wiring loom sway; rotation rate due to two vehicle rotation (e.g. due to cornering); rotation rate due to trailer rotation (e.g. due to snaking); rotation rate due to change in road slope; or rotation rate due to road noise.

In various embodiments, the inertial sensor includes a multi-axis accelerometer and a gyroscope.

In other embodiments, the inertial sensor includes a multi-axis accelerometer and a magnetometer.

In still other embodiments, the inertial sensor includes a multi-axis accelerometer, a gyroscope and a magnetometer.

In a particular embodiment, the inertial sensor includes two multi-axis accelerometers, wherein a first multi-axis accelerometer is positioned so as to be spatially separated from a second multi-axis accelerometer.

The brake controller has a fixed frame of reference and a moving frame of reference and the processor may use a digital filter to estimate changes between the fixed frame of reference and the moving frame of reference to determine a measured deceleration vector.

The insensitivity to forces other than the braking deceleration may be implemented by applying a three-dimensional rotation to the determined deceleration vector into a substantially fixed frame of reference before determining the braking deceleration. Furthermore, compensating for extraneous acceleration components may include applying a first estimation algorithm.

In some embodiments, the extraneous acceleration component is due to a change in road slope in one of the longitudinal or lateral directions and the application of an estimation filer ameliorates an effect of gravity. The first estimation algorithm may be a Kalman filter or an extended Kalman filter.

In some embodiments, the first estimation algorithm is updated with horizontal components of acceleration with an increased variance estimation while the vehicle is undergoing significant acceleration.

In other embodiments, the auxiliary vehicle data such as wheel speed is an additional input to the first estimation algorithm.

Compensating for rotation rate components may include applying a second estimation algorithm to the sensor data to estimate errors due to rotation rate components. Applying a second estimation algorithm may comprise applying an adaptive filter.

The second estimation algorithm may perform predictive equalisation from one or more inertial components with respect to a deceleration component.

In some embodiments, applying a second estimation algorithm comprises applying a least mean squares equalizer.

The application of an adaptive filter to the sensor data to compensate for rotation rate components may precede the application of the first estimation algorithm to compensate for extraneous acceleration components.

According to another aspect of the present invention, there is provided a brake controller adapted to generate a braking control signal to the towed vehicle braking system, the brake controller comprising: at least one inertial sensor adapted to sense inertial measurements in more than three sensor axes and generate sensor data associated with each of the sensor axes; a processor for processing the sensor data to estimate a braking deceleration; wherein the processor is adapted to compensate for at least one of extraneous acceleration components and rotation components in the sensor data such that the brake controller is adapted to generate the braking control signal to control activation of at least one brake associated with the towed vehicle braking system based on the braking deceleration that has been corrected for sensed forces other than the braking deceleration thereby adapting the brake controller to be mounted in various orientations that need not be fixed relative to the towed vehicle or a towing vehicle.

Throughout the description and claims of this specification the words “comprise” or “include” and variations of those words, such as “comprises”, “includes” and “comprising” or “including, are not intended to exclude other additives, components, integers or steps.

### BRIEF DESCRIPTION OF DRAWINGS

A preferred embodiment of the present invention will now be described with reference to the accompanying drawings wherein:

FIG. 1 shows a trailer braking system including a vehicle mounted brake controller;

FIG. 2 shows the standard conventions for pitch and roll;

FIG. 3 shows factors that contribute to errors in longitudinal braking direction which are compensated for by the algorithms provided in accordance with the present invention;

FIG. 4 shows factors that contribute to errors in lateral braking direction which are compensated for by the algorithms provided in accordance with the present invention.

FIG. 5 is a schematic diagram, showing inputs to the algorithms provided in accordance with the present invention; and

FIG. 6 is a schematic of a least mean squares equaliser.

### DETAILED DESCRIPTION

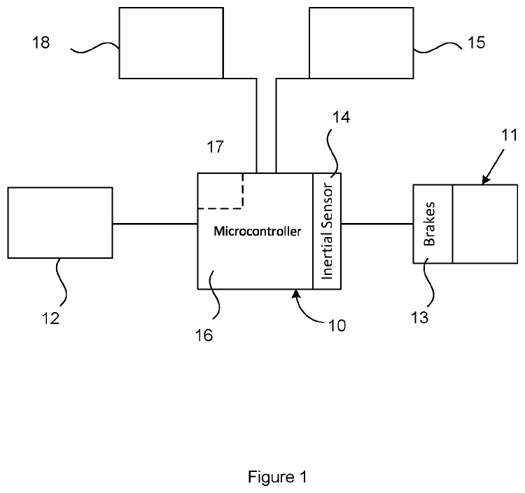

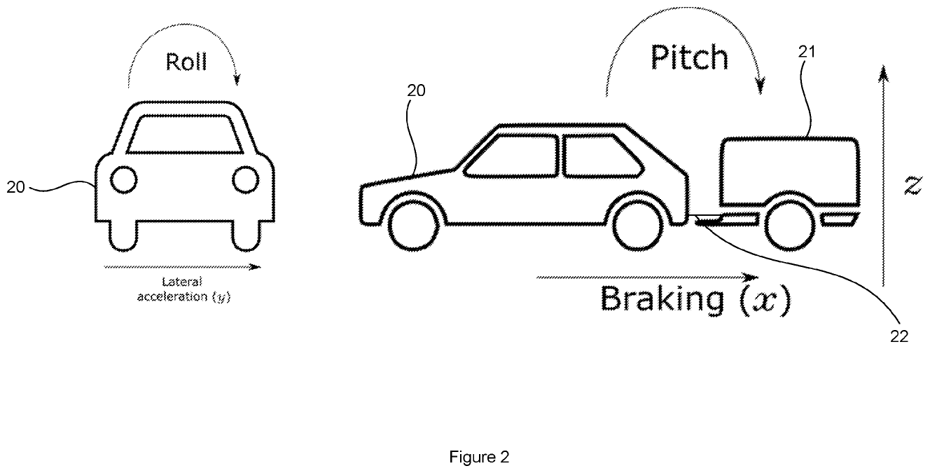

Referring firstly to FIGS. 1 and 2, FIG. 1 shows a trailer braking system including a brake controller 10 which may be mounted outside of a towing vehicle 20 (See FIG. 2), inside a towed vehicle 21 (see FIG. 2) or between the towing vehicle and the towed vehicle, such as on a wiring loom (not shown) between the towing vehicle and the towed vehicle. Controller 10 is associated via a wired connection, wireless connection, or vehicle bus connection with a remote head 12 for proving gain control, e.g. via a potentiometer, encoder, pushbutton or touch/swipe-sensitive surface, a pushbutton or touch sensitive button for status control and one or more LEDs for displaying status of the braking system. It may also be associated with one or more devices measuring other vehicle parameters such as wheel speed or acceleration. An example of such a device would be a module 18 connected to vehicle monitoring systems via an OBDII or CAN connector and communicating wirelessly with the brake controller.

Brake controller 10 is adapted to operate trailer brakes 13 based on sensed inertial measurement. The inertial measurements may include one or more of acceleration (or deceleration), rotation rate or angle. Brake controller 10 includes an inertial sensor 14 for sensing the inertial measurement in more than three sensor axes and to generate sensor data associated with each of the sensor axes. The inertial sensor is configured to sense inertial measurements in more the three degrees of freedom and can include a multi-axis accelerometer and a gyroscope, a multi-axis accelerometer and a magnetometer, or a multi-axis accelerometer, a gyroscope and a magnetometer. Alternatively, the inertial sensor may include two multi-axis accelerometers, with that the first multi-axis accelerometer positioned so as to be spatially separated from the second multi-axis accelerometer. Brake controller 10 includes an input 15 from the towing vehicle brake light circuit for determining when the vehicle brakes are applied.

Brake controller 10 includes a microprocessor or microcontroller 16 that processes the inertial sensor data to estimate a braking deceleration and to supply, responsive to the estimated braking deceleration, power to activate trailer brakes 13 that may be a function of the estimated braking deceleration. Microcontroller 16 is adapted to execute one or more algorithms stored in an associated memory such as RAM and/or ROM 17 to facilitate estimation of acceleration and/or braking force in a manner that is relatively insensitive to sensed forces other than braking deceleration. This configuration adapts the brake controller to be mounted in various orientations that need not be fixed relative to the towed vehicle or a towing vehicle. That is, the orientation of the brake controller may be changing in at least one of a pitch, roll or yaw direction (see FIG. 2).

Known brake controllers need to be compensated for artefacts as discussed above and are required to be installed in a predetermined orientation to allow braking force to be estimated along a single axis or alternatively need to be manually compensated for mounting orientation relative to the towing vehicle. The brake controller of the present invention is adapted to be substantially insensitive to forces other than braking deceleration. This adaptation involves compensating for one or more extraneous acceleration components and/or rotation rate components when generating the braking signal.

The extraneous acceleration components may be attributed to one or more of the following: acceleration due to gravity; acceleration due to sway on springs; acceleration due to wiring loom sway; acceleration due to change in road slope; acceleration rate due to road noise; or centripetal acceleration of tow vehicle or trailer. Examples of rotation components include rotation rate due to wiring loom sway; rotation rate due to two vehicle rotation; rotation rate due to trailer rotation; rotation rate due to change in road slope; or rotation rate due to road noise.

Described below are estimation algorithms that facilitate estimation of braking deceleration and braking force in a forward direction to ameliorate effects of various artefacts such as gravity and lateral acceleration, e.g. vehicle rocking on springs. It will be understood that each estimation algorithm described herein may be implemented independently, or in combination with another estimation algorithm, dependent on the desired outcome.

### Compensating for Extraneous Acceleration Components

In order to facilitate flexible orientation and/or installation location of the brake controller 10, a correction must be applied to the estimated braking deceleration for to compensate for errors. This correction which is described in detail below, constitutes and extension of and improvement on, the Inventor's earlier patent AU2017100513B4 directed to direction detection and braking estimation, which is herein incorporated by reference in its entirety.

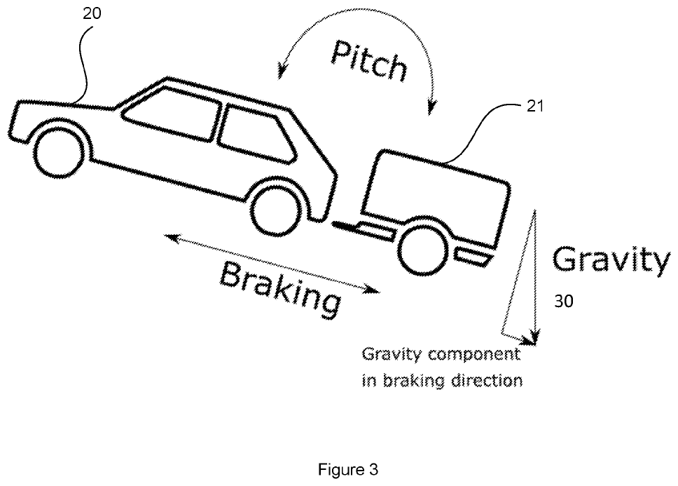

Referring now to FIG. 3, one source of errors addressed by the present invention is the change in direction of inertial measurement with respect to the gravity vector 30. Such changes in direction cause the inertial sensor 14 to measure a component of gravity in the same axis as the direction of braking, thereby increasing or decreasing the estimated braking deceleration.

For example, slope of the road surface on which the vehicle is travelling may be compensated for using an estimation algorithm, to estimate the value of the gravity vector 30. A reasonable simplified state vector (θ) for this model is given in Table 1. The angles are Euler angles which are not required to correspond directly to physical pitch and roll, rather they are only required to be orthogonal to one another and to the yaw axis.

TABLE 1
Kalman State Vector for Pitch Tracking

| Definition | Symbol |
|---|---|
| Vehicle combination pitch angle | α |
| Vehicle combination roll angle | β |
| Vehicle combination pitch rate | \dot{α} |
| Vehicle combination roll rate | \dot{β} |

The simplified state vector given in Table 1 ignores the differential pitch, yaw and roll of the towing vehicle 20 and towed vehicle or trailer 21 as well as the current state of acceleration and braking. It further ignores any movement of the brake controller 10 relative to the vehicle 20, since the combination of short distances and wiring loom stiffness mean that this sway should be above the operational bandwidth.

Observables for slope monitoring are given in Table 2:

TABLE 2
Observables for Slope Monitoring

| Definition | Symbol |
|---|---|
| Brake controller acceleration x | aₓ |
| Brake controller acceleration y | a_{y} |
| Brake controller acceleration z | a_{z} |
| Brake controller and vehicle combination combined pitch rate | \hat{\dot{α}} |
| Brake controller and vehicle combination combined roll rate | \hat{\dot{β}} |

These observables assume the inertial sensor includes a gyroscope, in accordance with a particular embodiment. If the inertial sensor includes a magnetometer, then the rotation noise may be high due to the small component of the terrestrial magnetic field in the vertical direction. Time-step τ«0.3 s is required for a braking estimation algorithm with control bandwidth of 3 Hz.

The state update function is linear:

$${θ}_{k} = {( \begin{matrix}α \\ β \\ \dot{α} \\ \dot{β}\end{matrix} )}_{k} = ( \begin{matrix}1 & 0 & τ & 0 \\ 0 & 1 & 0 & τ \\ 0 & 0 & 1 & 0 \\ 0 & 0 & 0 & 1\end{matrix} ) {( \begin{matrix}α \\ β \\ \dot{α} \\ \dot{β}\end{matrix} )}_{k - 1} + {w}_{k} = {F}_{k} {θ}_{k - 1} + {w}_{k}$$

### Equation 1: Slope Monitoring Estimation Algorithm State Update Function

As the control input model is unknown, remove it and use the process noise wₖ to model variation in road slope. wₖ˜ [symbol] (0, Qₖ) where Qₖ is a covariance matrix empirically derived from road pitch and camber measurements. A nominal value of:

$${Q}_{k} = A {τ}^{2} ( \begin{matrix}A & B & C & C \\ B & A & C & C \\ C & C & E & D \\ C & C & D & E\end{matrix} )$$

may be used as a rough estimate based on road smoothness estimations, where:

A=1000°²/s²(for Australian standard carpark speed humps)

B=0(changes in pitch and rollare not normally correlated)

C=0

D=0

E=10°²/s⁴

A different value of Qₖ may be applied for on/off road situations, or a modified Kalman gain such as Autocovariance Least Squares (ALS) may be used to eliminate the need for estimations of Qₖ.

The observation model is nonlinear as given below:

$${φ}_{k} = {( \begin{matrix}{a}_{x} \\ {a}_{y} \\ {a}_{z} \\ \dot{α} \\ \dot{β}\end{matrix} )}_{k} = h ( {θ}_{k} ) + {v}_{k} = ( \begin{matrix}- g \cdot sin {α}_{k} \\ - g \cdot sin {β}_{k} \\ - g \cdot cos {α}_{k} cos {β}_{k} \\ {\dot{α}}_{k} \\ {\dot{β}}_{k}\end{matrix} ) + {v}_{k}$$

Equation 2: Slope tracking Kalman Filter Observation Function

The Jacobian of h(xₖ) is:

$${J}_{k} = \frac{\partial h}{\partial {θ}_{k}} = ( \begin{matrix}- g cos {α}_{k} & 0 & 0 & 0 \\ 0 & - g cos {β}_{k} & 0 & 0 \\ g sin {α}_{k} cos {β}_{k} & g cos {α}_{k} sin {β}_{k} & 0 & 0 \\ 0 & 0 & 1 & 0 \\ 0 & 0 & 0 & 1\end{matrix} )$$

Equation 3: Jacobian of Kalman Filter Observation function which is used to determine updates to the estimated filter state:

The measurement noise is normally distributed with covariance Rₖ:

νₖ˜ [symbol] (0,Rₖ)

where Rₖ may be empirically derived from road noise measurements and datasheets of inertial sensors.
A nominal value may be used:

$${R}_{k} = {τ}^{2} ( \begin{matrix}{Ag}^{2} & {Bg}^{2} & {Bg}^{2} & Cg ° / s & Cg ° / s \\ {Bg}^{2} & {Ag}^{2} & {Bg}^{2} & Cg ° / s & Cg ° / s \\ {Bg}^{2} & {Bg}^{2} & {Ag}^{2} & Cg ° / s & Cg ° / s \\ Cg ° / s & Cg ° / s & Cg ° / s & E {°}^{2} / {s}^{2} & D {°}^{2} / {s}^{2} \\ Cg ° / s & Cg ° / s & Cg ° / s & D {°}^{2} / {s}^{2} & E {°}^{2} / {s}^{2}\end{matrix} )$$

Equation 4: Observation Noise Estimated Covariance where:

A=0.02 for acceleration noise

B=10⁻³ for cross-axis coupling

C=10⁻⁴ for mechanical coupling of acceleration into rotation noise (e.g. rocking on springs) after equalisation

D=10⁻⁵ for cross-axis coupling

E=10⁻³ for rotational noise

As acceleration and braking of the vehicle may bias this estimate, it is desirable to reduce or disable inputs that include acceleration and braking. This may be done by using a reduced set of parameters, being the last three entries of φₖ. As a result, the first two rows of the Jacobian Jₖ will be removed, and the covariance Rₖ will be reduced to its lower right quadrant 3×3 block. This reduced set of parameters should be used when the measured total acceleration differs from gravity by more than 10%—e.g. \sqrt{αₓ²+α_{y}²+_{z}²}>0.1 g. Alternatively, the full set of data φₖ may be used, but the acceleration components of Rₖ may be increased to compensate for the magnitude and coherence of the acceleration and braking signals.

The standard form of an estimation algorithm which may be a Kalman filter, or an extended Kalman filter, may be used as follows (assuming that the sample bandwidth is greater than the signal bandwidth to ensure linearisation).

### Initialisation

As part of an initialisation process, a vector basis is formed to approximate the vehicle frame of reference Xᵥₑₕ. The average acceleration measurement is used to initialise \vec{Z}ᵥₑₕ, as it approximates gravity. If the forward direction is known, it may be used to initialise \vec{X}ᵥₑₕ and \vec{y}ᵥₑₕ can be determined as the cross product of \vec{x}ᵥₑₕ and \vec{Z}ᵥₑₕ. If the forward direction is unknown, \vec{x}ᵥₑₕ can be chosen arbitrarily in the plane perpendicular to \vec{Z}ᵥₑₕ and \vec{y}ᵥₑₕ can be determined as the cross product of \vec{x}ᵥₑₕ and \vec{Z}ᵥₑₕ. The mapping from the inertial sensor's frame of reference to the intermediate frame is a fixed matrix multiplication:

$${X}_{acc} \to {X}_{veh} : {( \begin{matrix}x \\ y \\ z\end{matrix} )}_{veh} = {{A}^{- 1} ( \begin{matrix}x \\ y \\ z\end{matrix} )}_{acc}$$

where A is the 3×3 matrix formed by the column vectors [\vec{x}ᵥₑₕ, \vec{y}ᵥₑₕ, \vec{z}ᵥₑₕ]. All the estimation algorithm calculations are to be done in the basis Xᵥₑₕ.

In an alternative embodiment, the vector basis may be chosen based on an analysis of the principle components (PCA) of either 3D accelerometer or 3D gyroscope data, wherein the eigenvectors of the covariance matrix of the said data will be found to substantially correspond to the three cardinal directions of the vehicle's motion.

These vectors can then be re-ordered and corrected to approximate an orthonormal basis for Xᵥₑₕ.
In another alternative embodiment, \vec{x}ᵥₑₕ may be determined from the cross correlation of the yaw rate (i.e. the gyroscope measurements in direction \vec{z}ᵥₑₕ) with acceleration measurements.

The state estimations are initialised as follows (noting that the covariance matrix values are estimated only, and based on a timestep τ<0.1 s):

$${\hat{θ}}_{0 \vert 0} = E [ ( \begin{matrix}α \\ β \\ \dot{α} \\ \dot{β}\end{matrix} ) ] \approx ( \begin{matrix}0 \\ 0 \\ 0 \\ 0\end{matrix} )$$

Equation 5: Pitch/Roll State Initialisation

$${P}_{0 \vert 0} = Var [ ( \begin{matrix}α \\ β \\ \dot{α} \\ \dot{β}\end{matrix} ) ] \approx ( \begin{matrix}0.01 & 0.01 & - 0.1 & 0.01 \\ 0.01 & 0.01 & 0.01 & - 0.1 \\ - 0.1 & 0.01 & 0.1 & 0.01 \\ 0.01 & - 0.1 & 0.01 & 0.1\end{matrix} )$$

Equation 6: Pitch/Roll Covariance Initialisation=

### Prediction

\hat{θ}_{k″k-1}=Fₖ\hat{θ}_{k|k-1} Equation 7: Pitch/Roll State Prediction

P_{k|k-1}=FₖP_{k-1|k-1}Fₖ^{T}+Qₖ Equation 8: Pitch/Roll Covariance Prediction

where Fₖ, and Qₖ are as defined in Equation 1.

### Update

\tilde{y}ₖ=φₖ−h(\hat{θ}_{k|k-1}) Equation 9: Measurement Residual

\tilde{S}ₖ=JₖP_{k|k-1}Jₖ^{T}+Rₖ Equation 10: State Covariance Residual

Kₖ=P_{k|k-1}Jₖ^{T}\tilde{S}ₖ⁻¹ Equation 11: Estimation Algorithm Gain Linearized Approximation

\hat{θ}_{k|k}=\hat{θ}_{k|k-1}+Kₖ\tilde{y}ₖ Equation 12: Pitch/Roll State a Posteriori Estimate

P_{k|k}=(I−KₖJₖ)P_{k|k-1} Equation 13: Pitch/Roll Covariance a Posteriori Estimate

where:
φₖ is created from filtered sample data from accelerometer and gyroscope. If a magnetometer is used, the derivatives should be calculated digitally. If multiple accelerometers are used, then the differential centripetal acceleration should be calculated and converted to approximate rotation rates,
h is as defined in Equation 2, and
Jₖ is the Jacobian of the observation function as derived in Equation 3 and calculated with respect to the a-priori state vector \hat{θ}_{k|k-1}, and
Rₖ is the estimated measurement noise covariance (estimation shown in Equation 4)

As a matter of practical implementation, it may be desirable to apply a minimum value to P_{k|k} to improve tracking speed. For example, it would be reasonable to limit the absolute values of the entries of P_{k|k} to be greater than 10% of P_{0|0}.

As another matter of practical implementation, the post-fit residual may be evaluated from the a-posteriori estimate as \tilde{y}_{k|k}=φₖ−h(\hat{θ}_{k|k}). If this is greater than a threshold, which may be 0.1 g for the horizontal axes when filtered to a bandwidth of 3 Hz, then the data should not be used for correction.

In another alternate embodiment, the wheel speed, accelerator pedal position or vehicle fuel usage data may be used as another input to the estimation algorithm, either as a correction to the observables, or as a control input in Equation 1. In this case, the removal of estimates that may bias braking is not required.

### Slope Measurement Alternatives

In an alternative embodiment, the slope measurement could be implemented as a linear Kalman filter in the Lie algebra of the 3D rotation group SO(3). The computational effort of scalar multiplication in this implementation may be high.

In another alternative embodiment, the basis Xᵥₑₕ may vary, rather than being fixed. Transforming the state vector and covariance matrix as the basis changes in this implementation may be resource intensive.

In yet another embodiment, the estimation algorithm may be simplified. For example, a heuristic design may use a leaky integrator to track α and β. However, this may not be optimal, and may result in direction drift.

### Angular Correction

The outputs α and β may be used to update using a rotation matrix using the transformation:

$${X}_{veh} \to {X}_{corr} : {( \begin{matrix}x \\ y \\ z\end{matrix} )}_{corr} = {Θ ( \begin{matrix}x \\ y \\ z\end{matrix} )}_{veh}$$

$$where :$$

$$Θ = ( \begin{matrix}1 & 0 & 0 \\ 0 & cos α & - sin α \\ 0 & sin α & cos α\end{matrix} ) ( \begin{matrix}cos β & 0 & sin β \\ 0 & 1 & 0 \\ - sin β & 0 & cos β\end{matrix} ) = ( \begin{matrix}cos β & 0 & sin β \\ sin α sin β & cos α & - sin α cos β \\ - cos α sin β & sin α & cos α cos β\end{matrix} )$$

The output of the above calculation may be used in brake controllers that use a “horizon” detection method (as described e.g. in AU2017100513B4, U.S. Pat. No. 9,150,201B2 or U.S. Pat. No. 6,445,993B1), whereby a frame of reference parallel to the horizon is determined prior to braking, and the total acceleration in that plane is then used to estimate braking deceleration. A variation of the ‘horizon’ method may be implemented by estimating a gravity vector prior to braking, subtracting this gravity vector from the measured acceleration during braking, and using the magnitude of the resulting vector as an estimate of braking deceleration.

Where the “horizon” detection methods subtract a gravity vector from the acceleration vector (or conversely use it as a reference point), this should be measured in the Xᵥₑₕ frame of reference and transformed into X_{corr} before being used. In this way, it will track the actual value of gravity, regardless of vehicle rotations.

When used in combination with the said “horizon” braking algorithms, this invention additionally allows the brake controller to compensate more generally for movements of the brake controller that introduce elements of gravity in the horizontal plane including the braking direction (above) and the lateral direction (as detailed below).

### Compensating for Rotation Rate Components

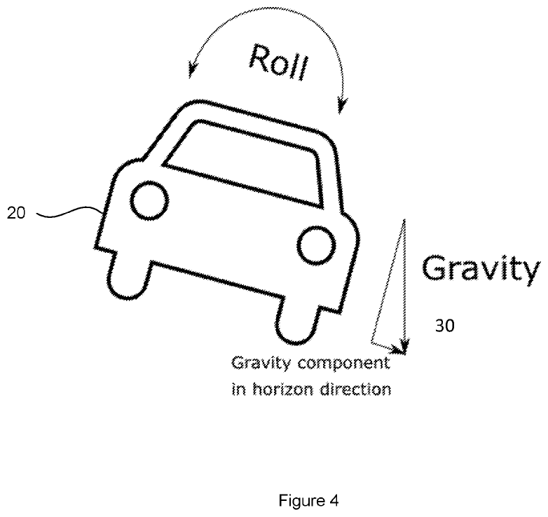

Referring now to FIG. 4, another source of errors in the estimated braking deceleration is lateral acceleration. For example, lateral acceleration may take the form of rocking of the vehicle 20 on its springs, wiring loom sway, change in road slope, and the like. These type of errors or noise may be compensated for, at least in part, by use of an estimation algorithm that predicts components of lateral acceleration on the basis of measured components of angular velocity/acceleration. This estimation algorithm may be used in combination with the above directional braking estimation algorithms as well as the horizon algorithm.

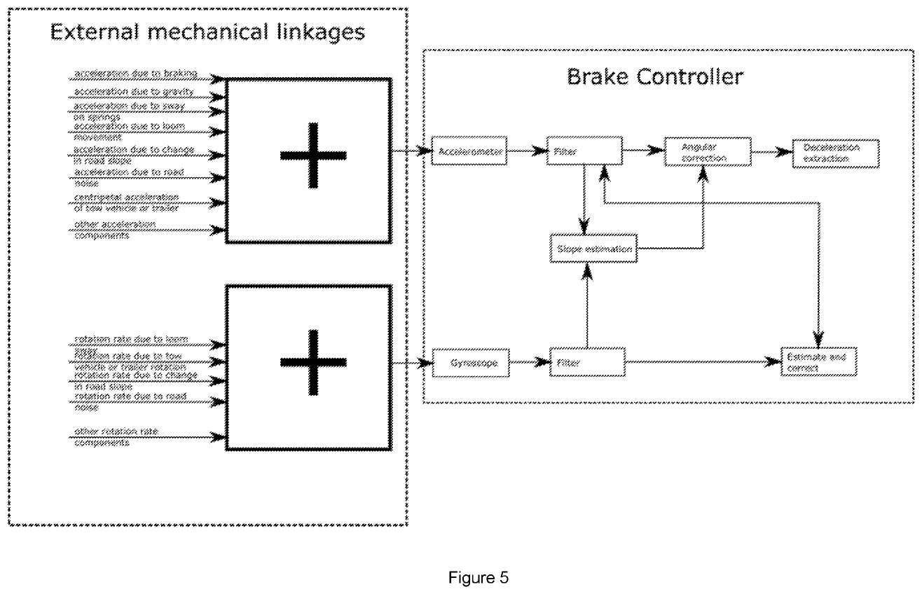

Referring now to FIG. 5, the inputs to the left of the diagram represent exemplary measurement and error components or noise inputs. The blocks represent possible mechanical combination of the inertial measurements via physical linkages prior to sensor measurement. Not all blocks need be present in all embodiments of the invention.

The combined values are measured by inertial sensors in more than three degrees of freedom. That is, a minimum of three accelerometer axes and additional measurements to capture rotation and/or rotation rate are required. For example, rotation can be estimated using a magnetometer, and rotation rate can be estimated using a gyroscope. Rotation can alternatively be measured using three accelerometer axes that are spatially separated, i.e. centred on a different location to the first three accelerometer axes.

### Extension for Removal of Rocking Acceleration

Since a towing vehicle rotates in a rocking motion on its springs in various directions, two effects will be sensed as an acceleration by an inertial sensor located in the vehicle:
1. Centripetal acceleration, with magnitude proportional to rotation rate:

\vec{A_{c}}=\vec{r}₁∥\vec{ω}∥²

where

$$\vec{ω} = ( \begin{matrix}\dot{α} \\ \dot{β} \\ \dot{γ}\end{matrix} )$$

and \vec{r}₁ is the instantaneous radius of rotation. When driving in a roughly straight line, \vec{r}₁ will be a function of spring forces and location of the accelerometer. When driving in a curve, \vec{r}₁ will be largely the radius of the curve.
2. Acceleration due to sway relative to the centre of rotation. This is proportional to the angular acceleration:

\vec{A_{α}}=R₂ω,

with R₂ being a tensor function of the instantaneous radius of rotation.

Coriolis acceleration is not considered, since the brake controller should not be moving relative to the towing or towed vehicle. Furthermore, centripetal acceleration is smaller than acceleration due to sway and is therefore not explicitly considered.

The total acceleration measured by inertial sensors will include centripetal and sway components, which will contribute to make the inertial measurement inaccurate. The present invention provides a method that will ameliorate such inaccuracies. This is applicable primarily to brake controllers using the “horizon” methods described above, since it removes lateral acceleration components relating to vehicle rocking. It will additionally improve performance for accelerometers that filter in the forward or longitudinal direction only, but to a smaller extent, since longer axle spacing reduces rocking in this longitudinal direction. This algorithm will also improve performance of the slope correction described above, by reducing the covariance values (C) for mechanical coupling of acceleration into rotation noise.

Methods rely on precise filtering techniques to remove lateral acceleration components at spring natural frequencies. It can be difficult to tune such filters, and even when carefully tuned, any inputs will be noisy. Tuning is also likely to shift with temperature of springs and loading of vehicles. Blind equalisation may be a viable alternative.

Accordingly, the approach involves filtering gyroscope inputs to predict and subtract the effects of sway from inertial sensor output. This may be done by means of any of the following:
1. A naïve periodic estimation of cross correlation between gyroscope and derivative of gyroscope data and accelerometer output used to estimate a transfer function.
2. Any standard equalisation techniques (e.g. Wiener, least mean squares (LMS), stochastic gradient (SG), recursive least squares (RLS), or RLS stabilised using Cholesky factorisation)
3. Using an artificial neural network (ANN), with a preference for long-short-term memory architecture.

The preferred embodiment is use of a least mean squares (LMS) equaliser. The LMS filter is preferred to artificial neural network (ANN) methods due to speed of convergence and the availability of derivable performance guarantees. It is preferred to stochastic gradient (SG) and recursive least squares (RLS) due to its comparable simplicity and numerical stability. Implementation of the LMS equaliser is detailed below.

### Design

Design of the least mean squares (LMS) filter is intended to generate an finite impulse response (FIR) filter foe predicting acceleration from gyroscope movement. Infinite impulse response (IIR) LMS algorithms are not preferred for this implementation, since they have the potential to settle to a local minimum, rather than to a global optimum prediction. A transient due to lateral acceleration, e.g. rocking on springs, is expected to be less than 2 seconds long, and therefore the FIR filter bank to be optimised is 2 seconds in length. To reduce the overall filter length, it will operate on minimum bandwidth data (10 Hz), making the total filter approximately 20 taps.

The estimation algorithm operates with three inputs and three outputs, and accordingly has a 3×3 matrix coefficient for each tap (i.e. [symbol] is a 3×3×20 tensor). Some simplification may be possible assuming that each coefficient matrix is the sum of a trace and a skew-symmetric matrix.

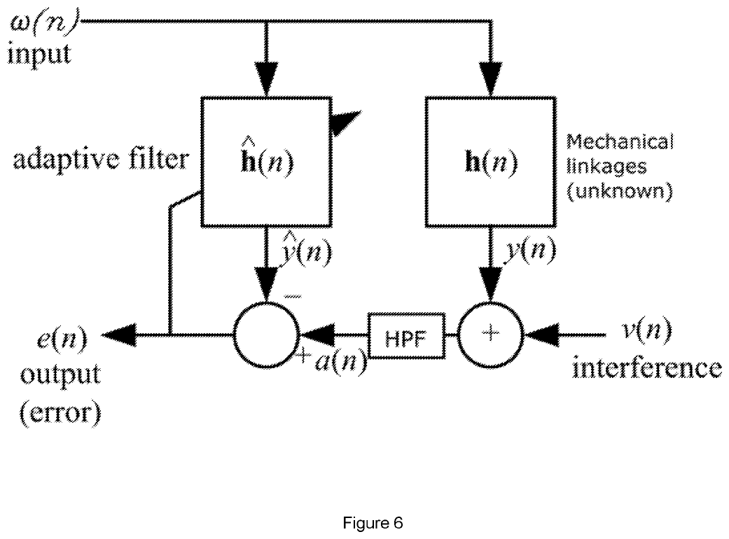

Referring now to FIG. 6, implementation of the estimation algorithm is described below, where [symbol] is the estimated adaptive filter,

$$\vec{ω} = ( \begin{matrix}\dot{α} \\ \dot{β} \\ \dot{γ}\end{matrix} )$$

is the filtered gyroscope output,

$$a ( n ) = ( \begin{matrix}{x}_{n} \\ {y}_{n} \\ {z}_{n}\end{matrix} )$$

is the band-pass filtered accelerometer output, and ν(n) is the combined inertial sensor noise and system error including centripetal acceleration due to cornering. Note that to prevent errors where gravity is identified as a result of constant offsets in gyroscope output, a high-pass filter (HPF) is applied to remove gravity before calculation of the error function.

### Initialisation

Initially, ĥ(0) is set to 0, and the learning rate λ=0.1. Reset is required on a change of vehicle and may be triggered on a power-on-reset.

### Update

The update step is run independently for the three dimensions of acceleration, and is calculated as follows:

ω(n)=\dot{α}ₙ,\dot{β}ₙ,\dot{γ}ₙ,\dot{α}ₙ₋₁,\dot{β}ₙ₋₁,\dot{γ}ₙ₋₁, . . . ,\dot{α}ₙ₋₂₀,\dot{β}ₙ₋₂₀,\dot{γ}ₙ₋₂₀] Equation 14: Definition of LMS input vector

$${e}_{x} ( n ) = {a}_{x} ( n ) - {\hat{h}}_{x}^{H} ( n ) ω ( n ) \\ \hat{{h}_{x}} ( n + 1 ) = \hat{{h}_{x}} ( n ) + \frac{λ {e}_{n} ( n ) ω ( n )}{{‖ ω ( n ) ‖}^{2}} \\ Update of LMS Coefficients \qquad Equation 15$$

where ĥₓ^{H} is the Hermitian transpose of [symbol] . The equations for y and z are equivalent, and the final, ĥ is formed by concatenating the contents of [symbol] and [symbol] . Note that there are therefore effectively three independent filters.

### Stop/Start

If it is detected that the vehicle has stopped, or the value of ∥\vec{α}(n)∥ is too low (i.e. below 0.1 g) for the length of the filter (2 seconds), then the update step should not be run.

### Usage

When ∥e(n)∥<0.1 gᵣₘₛ, then the predicted output y(n) is a reasonable estimate of the errors due to vehicle rotation on springs, and may be subtracted from the measured acceleration for an improved estimation of acceleration due to braking.

### Combined Correction of Extraneous Acceleration Components and Rotation Rate

In some embodiments of the invention, an estimation algorithm, such as an extended Kalman filter is used to track the yaw rate and pitch and roll angles of the brake controller. The angular correction step takes a long-term mean gravity magnitude (or theoretical gravity measurement), projected onto the gravitational axis predicted by the pitch and roll angles (being the first three entries of the predicted measurement vector of the observation model in Equation 2). This result is subtracted from the acceleration measurement in order to ameliorate the effects of gravity. This is an improvement over current practice, which uses a gated gravity estimation which is not tracked during braking. The result of the improvement is that braking will be consistent with vehicle deceleration, even when if slope of the road changes.

In this embodiment, the “deceleration extraction” stage includes a low pass filter with a bandwidth of 3-5 Hz to reduce or remove under-damped movement modes of the brake controller that are related to the stiffness of the wiring loom.

It is an advantage of the present invention that a brake controller is provided which has improved versatility in the sense that it may be installed inside of the towing vehicle or outside of the towing vehicle, such as on the towed vehicle or between the towing vehicle and the towed vehicle, for example on a wiring loom. Moreover, strict attention to the orientation of the brake controller at installation is not required. This advantageously enables the brake controller to be installed by a lay person that need not possess any particular skill which saves cost and inconvenience on installation and further enables the brake controller to be moved between vehicles further enhancing its versatility and convenience.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

1. A brake controller for a towed vehicle braking system, the brake controller adapted to generate a braking control signal to the towed vehicle braking system, the brake controller comprising:
at least one inertial sensor adapted to sense inertial measurements in more than three sensor axes, including at least one axis of angle or rotation rate sensing, and generate sensor data associated with each of the sensor axes;
a processor for processing the sensor data to estimate a braking deceleration;
wherein the brake controller is adapted to generate the braking control signal to control activation of at least one brake associated with the towed vehicle braking system based on the braking deceleration in a manner that is relatively insensitive to sensed forces other than the braking deceleration thereby adapting the brake controller to be mounted in orientations that need not be fixed relative to the towed vehicle or a towing vehicle.

2. A brake controller according to claim 1, wherein the inertial measurements further include acceleration in addition to at least one of rotation rate or angle.

3. A brake controller according to claim 1, wherein the brake controller is adapted to be mounted outside of the towing vehicle.

4. A brake controller according to claim 1, wherein the brake controller is adapted to be mounted in the towed vehicle or between the towing vehicle and the towed vehicle.

5. A brake controller according to claim 1, wherein the brake controller is adapted to be mounted on and substantially supported by a wiring loom.

6. A brake controller according to claim 1, wherein the orientation of the brake controller is changing in at least one of a pitch, roll or yaw direction.

7. A brake controller according to claim 1, wherein adapting the brake controller to be insensitive to forces other than braking deceleration involves compensating for one or more extraneous acceleration components when generating the braking signal.

8. A brake controller according to claim 1, adapting the brake controller to be insensitive to forces other than braking deceleration involves compensating for one or more rotation rate components when generating the braking control signal.

9. (canceled)

10. (canceled)

11. A brake controller according to claim 1, wherein the at least one multi-axis inertial sensor includes one or more of a multi-axis accelerometer, a gyroscope and a magnetometer.

12. A brake controller according to claim 1, wherein the at least one inertial sensor includes two multi-axis accelerometers, wherein a first multi-axis accelerometer is positioned so as to be spatially separated from a second multi-axis accelerometer.

13. A brake controller according to claim 7, wherein the brake controller has a fixed frame of reference and a moving frame of reference and the processor uses a digital filter to estimate changes between the fixed frame of reference and the moving frame of reference to determine a measured deceleration vector.

14. A brake controller according to claim 13, wherein the insensitivity to forces other than braking deceleration is implemented by applying a three-dimensional rotation to the determined deceleration vector into a substantially fixed frame of reference before determining the braking deceleration.

15. A brake controller according to claim 14 wherein the three dimensional rotation is determined from a principle components analysis (PCA) of gyroscope or acceleration data.

16. A brake controller according to claim 14 wherein lateral basis vector of the three dimensional rotation is determined using cross correlation of yaw rate and accelerometer measurements.

17. A brake controller according to claim 7, wherein compensating for extraneous acceleration components includes applying a first estimation algorithm.

18. A brake controller according to claim 17, wherein the extraneous acceleration component is due to a change in road slope in one of the longitudinal or lateral directions and wherein the application of the first estimation algorithm ameliorates an effect of gravity.

19. A brake controller according to claim 17, wherein the first estimation algorithm is a Kalman filter or an extended Kalman filter.

20. A brake controller according to claim 19, wherein the first estimation algorithm is updated with horizontal components of acceleration with an increased variance estimation while the vehicle is undergoing significant acceleration.

21. A brake controller according to claim 19, wherein auxiliary vehicle data such as wheel speed is an additional input to the first estimation algorithm.

22. A brake controller according to claim 8, wherein compensating for rotation rate components includes applying a second estimation algorithm to the sensor data to estimate errors due to rotation rate components.

23. A brake controller according to claim 22, wherein applying the second estimation algorithm comprises applying an adaptive filter.

24. A brake controller according to claim 23, wherein the second estimation algorithm performs predictive equalisation from one or more inertial components with respect to a deceleration component.

25. A brake controller according to claim 23, wherein applying the second estimation algorithm comprises applying a least mean squares equalizer.

26. A brake controller according to claim 17, wherein the application of an adaptive filter to the sensor data to compensate for rotation rate components precedes the application of the first estimation algorithm to compensate for extraneous acceleration components.

27. A brake controller for a towed vehicle braking system, the brake controller adapted to generate a braking control signal to the towed vehicle braking system, the brake controller comprising:
at least one inertial sensor adapted to sense inertial measurements in more than three sensor axes, including at least one axis of angle or rotation rate sensing, and generate sensor data associated with each of the sensor axes;
a processor for processing the sensor data to estimate a braking deceleration;
wherein the processor is adapted to compensate for at least one of extraneous acceleration components and rotation components in the sensor data such that the brake controller is adapted to generate the braking control signal to control activation of at least one brake associated with the towed vehicle braking system based on the braking deceleration that has been corrected for sensed forces other than the braking deceleration thereby adapting the brake controller to be mounted in orientations that need not be fixed relative to the towed vehicle or a towing vehicle.

28. A brake controller for a towed vehicle braking system, the brake controller adapted to generate a braking control signal to the towed vehicle braking system, the brake controller comprising:
at least one inertial sensor adapted to sense inertial measurements in more than three sensor axes, including at least one axis of angle or rotation rate sensing, and generate sensor data associated with each of the sensor axes;
a processor for processing the sensor data to estimate a braking deceleration;
wherein the brake controller is adapted to generate the braking control signal to control activation of at least one brake associated with the towed vehicle braking system based on the braking deceleration in a manner that is relatively insensitive to changes in road slope.

29. A brake controller according to claim 28, wherein application of a first estimation algorithm ameliorates an effect of gravity rotated into the forward or lateral directions due to road slope.

30. A brake controller according to claim 28, wherein the first estimation algorithm is a Kalman filter or an extended Kalman filter with at least one input coming from said angle or rotation rate measurement.

31. A brake controller according to claim 30, wherein the first estimation algorithm is updated with horizontal components of acceleration with an increased variance estimation while the vehicle is undergoing acceleration.

32. A brake controller according to claim 30, wherein auxiliary vehicle data, including wheel speed, is an additional input to the first estimation algorithm.
